(19) United States
(12) Patent Application Publication
(10) Pub. No.: US 2014/0223108 A1
(43) Pub. Date: Aug. 7, 2014

(54) HARDWARE PREFETCH MANAGEMENT FOR PARTITIONED ENVIRONMENTS

(71) Applicant: INTERNATIONAL BUSINESS MACHINES CORPORATION, Armonk, NY (US)

(72) Inventors: Peter J. Heyrman, Rochester, MN (US); Bret R. Olszewski, Austin, TX (US)

(73) Assignee: INTERNATIONAL BUSINESS MACHINES CORPORATION, Armonk, NY (US)

(21) Appl. No.: 13/761,469

(22) Filed: Feb. 7, 2013

(51) Int. Cl. G06F 12/08

(52) U.S. Cl. CPC G06F 12/0862
USPC 711/137

(57) ABSTRACT

This disclosure includes a method for managing hardware prefetch policy of a partition in a partitioned environment which includes dispatching a virtual processor on a physical processor of a first node, assigning a home memory partition of a memory of a second node to the virtual processor, determining whether the first node and the second node are different nodes, disabling hardware prefetch for the virtual processor when the first node and the second node are different nodes, and enabling hardware prefetch when the first node and the second node are the same physical node.

This disclosure relates to hardware prefetch management. In particular, it relates to hardware prefetch management in partitioned environments.

### BACKGROUND

Processors reduce delays in data access by utilizing hardware prefetch techniques. Hardware prefetch involves sensing a memory access pattern and loading instructions from main memory to a stream buffer, which may then be loaded into a lower level cache upon a cache miss. This prefetching makes the data available for quick retrieval when the data is to be accessed by the processor. Sensing memory access patterns is utilized for speculative prediction and often the processor may fetch instructions that will not soon be required by the system. Unused instructions may flood the memory, replacing useful data and consuming memory bandwidth. Falsely prefetched instructions are especially problematic in non-uniform memory access (NUMA) systems used in partitioned environments. In these systems, memory may be shared between local and remote processors, and an increase in memory use by a partition may affect unrelated but architecturally intertwined systems.

### SUMMARY

In an embodiment, a method for managing hardware prefetch policy of a partition in a partitioned environment includes dispatching a virtual processor on a physical processor of a first node, assigning a home memory partition of a memory of a second node to the virtual processor, determining whether the first node and the second node are different physical nodes, disabling hardware prefetch for the virtual processor when the first node and the second node are different physical nodes, and enabling hardware prefetch for the virtual processor when the first node and the second node are the same physical node.

In another embodiment, a computer system for managing hardware prefetch policy for a partition in a partitioned environment includes a physical processor of a first node, a memory of a second node, and a hypervisor. The hypervisor is configured to dispatch a virtual processor on the physical processor, assign a home memory partition of the memory to the virtual processor, determine whether the first node and the second node are different physical nodes, disable hardware prefetch for the virtual processor when the first node and the second node are different physical nodes, and enable hardware prefetch when the first node and the second node are the same physical node.

### BRIEF DESCRIPTION OF THE DRAWINGS

The drawings included in the present application are incorporated into, and form part of, the specification. They illustrate embodiments of the present invention and, along with the description, serve to explain the principles of the invention. The drawings are only illustrative of typical embodiments of the invention and do not limit the invention.

FIG. 1 is a diagram of a virtualized multiprocessor system using distributed memory.

FIG. 2 is a flowchart of a method of managing hardware prefetch in a partitioned multiprocessor environment using distributed memory, according to embodiments of the invention.

FIG. 3 is a diagram of a computer system for managing hardware prefetch in a partitioned multiprocessor environment using distributed memory, according to embodiments of the invention.

### DETAILED DESCRIPTION

A multiprocessing computer system may use non-uniform memory access (NUMA) to tier its memory access for faster memory access and better scalability in symmetric multiprocessors. A NUMA system includes groups of components (referred to herein as “nodes”) that each may contain one or more physical processors, a portion of memory, and an interface to an interconnection network that connects the nodes. A processor may access any memory in the computer system, including from another node. If the memory shares the same node as the processor, it is referred to as “local memory”; if the memory does not share the same node as the processor, it is referred to as “remote memory.” A processor has lower latency for local memory than remote memory.

In hardware virtualization, physical processors and a pool of memory may be allocated to logical partitions. A virtual machine manager (herein referred to as a “hypervisor”) dispatches one or more virtual processors on a physical processor to a logical partition for a dispatch cycle. A virtual processor constitutes an allocation of physical processor resources to a logical partition. The hypervisor may assign a home memory partition to the virtual processor, which is an allocation of physical memory resources to the logical partition. The virtual processor's home memory may or may not be on the same node as the virtual processor's physical processor. In an ideal system, the hypervisor may assign local memory as the virtual processor's home memory; this is most likely the case when few virtual processors are operating. However, there may be conditions, such as overcommitment of a node's memory to currently dispatched virtual processors on the physical processor of the node, for which a hypervisor may allocate remote memory as a virtual processor's home memory.

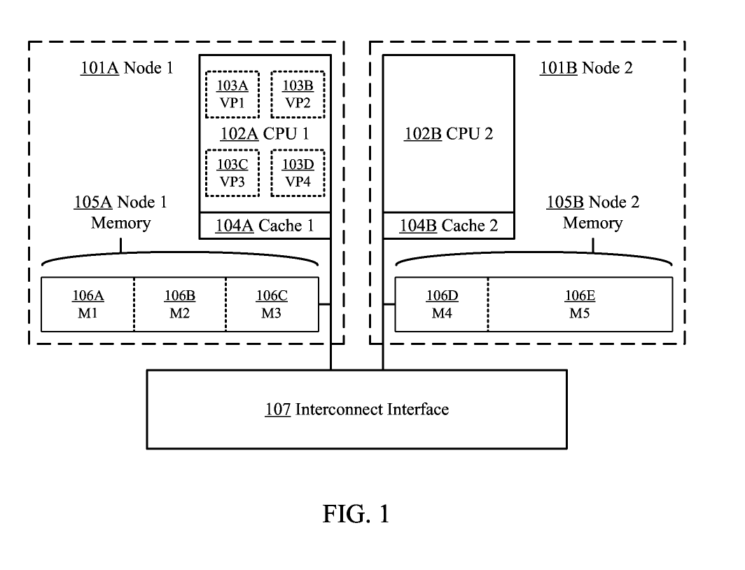

FIG. 1 is a diagram of a virtualized multiprocessor system using distributed memory. A multiprocessor has Node 1 101A and Node 2 101B. Node 1 101A includes a CPU 1 102A, a Cache 1 104A, and a Node 1 Memory 105A connected to an Interconnect Interface 107; similarly, Node 2 101B includes a CPU 2 102B, a Cache 2 104B, and a Node 2 Memory 105B connected to the Interconnect Interface 107. A hypervisor dispatches virtual processors VP1 103A, VP2 103B, and VP3 103C, as well as assigns each virtual processor a memory partition M1 106A, M2 106B, and M3 106C, respectively, of Node 1 Memory 105A. M5 106E represents the remaining memory on Node 2 Memory 105B. When the hypervisor dispatches virtual processor VP4 103D on CPU 1 102A, it may not allocate home memory for VP4 103D on Node 1 Memory 105A, and may assign its home memory M4 106D on Node 2 Memory 105B. In this case, M4 106D would be remote memory for VP4 103D.

Hardware prefetch may cause negative performance for virtualized multiprocessors using distributed memory systems such as NUMA. Hardware prefetch may be effective when memory affinity between virtual processors and their software is maintained. Active partitions consume memory bandwidth, and as the number of virtual processors increases, memory affinity becomes more difficult to sustain. Once a virtual processor accesses remote memory instead of local memory, hardware prefetch may not be worth the bandwidth it consumes.

### Method Structure

According to the principles of the invention, a multiprocessor may manage a virtual processor's hardware prefetch policy by evaluating the memory affinity of the home memory assigned to the virtual processor. A hypervisor dispatches a virtual processor on a physical processor and determines whether the home memory is local (same node) or remote (different node). If the home memory is local, hardware prefetch may be enabled for the virtual processor. If the home memory is remote, hardware prefetch may be disabled for the virtual processor. Referring to FIG. 1, virtual processor VP4 103D would have its hardware prefetch disabled, as M4 106D is remote memory for that virtual processor.

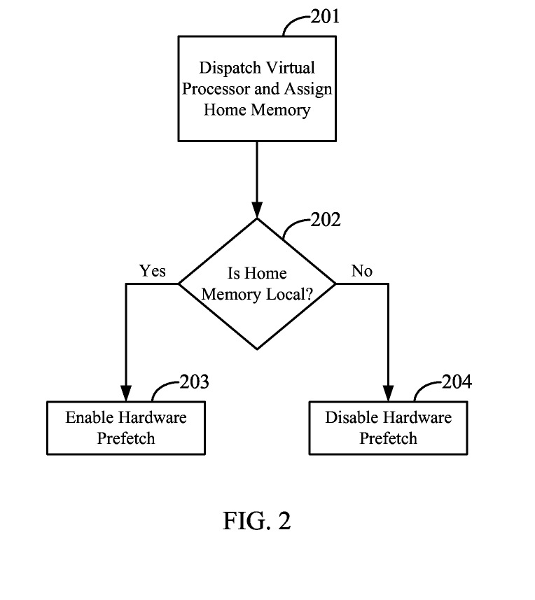

FIG. 2 is a flowchart of a method for managing hardware prefetch in a partitioned multiprocessor environment using distributed memory, according to embodiments of the invention. A hypervisor dispatches a virtual processor on a physical processor for a dispatch cycle and allocates a home memory to the virtual processor, as in 201. The hypervisor evaluates whether the home memory is local or remote, as in 202. If the home memory is local, the hypervisor enables hardware prefetch on the virtual processor, as in 203. If the home memory is not local, the hypervisor disables hardware prefetch on the virtual processor, as in 204.

The above method may improve multiprocessor operation by disabling hardware prefetch for remote memory configurations for which the prefetch performance benefit may not be worth the load on the system. A hypervisor is unlikely to allocate remote memory to a virtual processor unless there is increased memory bandwidth consumption due to multiple active partitions, as remote memory takes longer to access. Assignment of remote memory acts as a trigger for the virtual processor to disable hardware prefetch on virtual processors where memory access may be most negatively impacted by hardware prefetch. The hypervisor may manage the hardware prefetch as a potential memory load that is enabled when it may be most efficiently used (local memory) and disabled when it is least efficiently used (remote memory).

Additionally, the assignment of remote memory to a virtual processor may cause potential degradation of system performance due to bandwidth on the interconnection network between nodes. The interconnection network between nodes may have a fixed bandwidth, and more frequent access to remote memory may saturate the interconnection network. By limiting hardware prefetch to local memory, the hypervisor may reduce the load on the interconnection network.

In addition to the hypervisor controlling hardware prefetch at dispatch of the virtual processor, a partition may have partial or full control over the hardware prefetch policy of virtual processors allocated to the partition. A partition may have logic that inputs into or overrides the hypervisor's opportunistic enablement of hardware prefetch based on memory affinity. Partition control logic may input the prefetch parameters into the hypervisor, which uses the prefetch parameters along with the hardware prefetch policy to enable or disable hardware prefetch for a memory affinity status. For example, partition control logic may disable all hardware prefetch for both local and remote memory based on input from a program that is memory intensive.

### Hardware Implementation

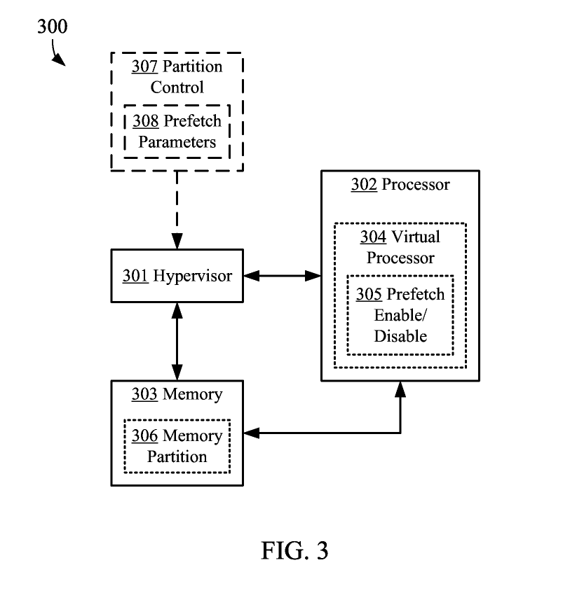

FIG. 3 is a diagram of a computer system for managing hardware prefetch policy for a partitioned environment using distributed memory, according to embodiments of the invention. A computer system 300 includes a processor 302, a memory 303, and a hypervisor 301. The hypervisor 301 dispatches a virtual processor 304 onto the processor 302 and allocates a home memory partition 306 on the memory 303. The virtual processor includes a prefetch enable/disable 305 that may be controlled by the hypervisor 301 for a dispatch cycle. In addition to control by the hypervisor 301, a partition associated with the virtual processor 304 and memory partition 306 may control the hardware prefetch function through partition control logic 307 that includes a set of partition parameters 308. The partition parameters 308 may include supplemental or overriding controls.

The hypervisor 301 may be hardware, firmware, or software. Typically, the hypervisor 301 is software loaded onto a host machine either directly (type I) or on top of an existing operating system (type II). The physical processor 302 may be any processor that supports virtualization and logical partitioning, including those with multiple cores. The memory 303 used may have a distributed, non-uniform memory access system where memory access is tiered and its access speed is influenced by memory affinity. The prefetch enable/disable logic 305 and the partition control logic 307 may be software, hardware, or firmware, such as an entry in a machine state register (MSR).

Although the present invention has been described in terms of specific embodiments, it is anticipated that alterations and modifications thereof will become apparent to those skilled in the art. Therefore, it is intended that the following claims be interpreted as covering all such alterations and modifications as fall within the true spirit and scope of the invention.

What is claimed is:

1. A method for managing hardware prefetch policy of a partition in a partitioned environment, comprising:
dispatching a virtual processor on a physical processor of a first node, wherein the virtual processor is configured for hardware prefetch;
assigning a home memory partition of a memory of a second node to the virtual processor;
determining whether the first node and the second node are different physical nodes;
disabling hardware prefetch for the virtual processor when the first node and the second node are different physical nodes; and
enabling hardware prefetch for the virtual processor when the first node and the second node are the same physical node.

2. The method of claim 1, wherein the partitioned environment comprises a non-uniform memory access architecture.

3. The method of claim 1, wherein the dispatching, assigning, determining, disabling, and enabling are performed by a hypervisor.

4. The method of claim 3, further comprising:
inputting prefetch parameters to the hypervisor from partition control logic; and
using the hardware prefetch policy and the prefetch parameters provided by the partition control logic for enabling and disabling hardware prefetch for the virtual processor.

5-7. (canceled)
